(19) United States
(12) Patent Application Publication
(10) Pub. No.: US 2025/0310669 A1
(43) Pub. Date: Oct. 2, 2025

(54) OPTICAL NETWORK MANAGEMENT DEVICE AND OPTICAL NETWORK MANAGEMENT METHOD

(71) Applicant: Fujitsu Limited, Kawasaki-shi (JP)

(72) Inventors: Takanori SASAKI, Takaoka (JP); Mie MAEHARA, Machida (JP)

(73) Assignee: Fujitsu Limited, Kawasaki-shi (JP)

(21) Appl. No.: 19/060,044

(22) Filed: Feb. 21, 2025

(30) Foreign Application Priority Data
Mar. 28, 2024 (JP) 2024-053975

(51) Int. Cl. H04Q 11/00

(52) U.S. Cl. CPC H04Q 11/0062; H04Q 2011/0086

(57) ABSTRACT

A device manages an optical network, and includes a processor coupled to a memory and configured to acquire a first number, which is the number of first channels used between the unit optical networks, from information including the first number and a second number, which is the number of second channels used in a network of each unit optical network belonging to the optical network, and when addition of another unit optical network to the optical network is requested, before a third number according to the first number of first channels used between each unit optical network and the another unit optical network are reserved in a database managing channels, release some of predetermined channels already reserved when the database does not have enough free channels, and allocate a reservation of the third number of the first channels to free channels after the some of the predetermined channels are released.

### CROSS-REFERENCE TO RELATED APPLICATION

This application is based upon and claims the benefit of priority of the prior Japanese Patent Application No. 2024-053975, filed on Mar. 28, 2024, the entire contents of which are incorporated herein by reference.

### FIELD

A certain aspect of embodiments described herein relates to an optical network management device and an optical network management method.

### BACKGROUND

Optical networks in which a plurality of nodes are connected in a ring or mesh form by optical fibers are known. As a node, for example, a reconfigurable optical add/drop multiplexer (ROADM) is known. A huge number of optical paths are set up and accommodated in an optical network. The optical path is a series of communication paths connecting a start node and an end node in the optical network. In the design of optical networks, wavelengths of optical signals are allocated to each optical path in the optical network as disclosed in, for example, Japanese Patent Application Laid-Open No. 2014-039208 (Patent Document 1).

Various methods have been proposed for setting up optical paths. For example, a method has been proposed in which, every time setting of an optical path is requested, an available route and an available wavelength that can open the optical path are searched, the influence of transmission deterioration factors of the available route on communication quality is evaluated, and the optical path is set when transmission characteristics can be maintained. As a transmission deterioration factor, for example, polarization mode dispersion (PMD) is known as disclosed in, for example, Japanese Patent Application Laid-Open No. 2010-199891 (Patent Document 2).

A method has also been proposed in which routes and wavelengths are reserved for allocation based on demand planning prior to wavelength opening requests, and optical paths are allocated based on the design results as disclosed in, for example, Japanese Patent Application Laid-Open No. 2011-023981 (Patent Document 3).

### SUMMARY

According to an aspect of the embodiments, there is provided an optical network management device that manages an optical network in which unit optical networks are optically connected, the optical network management device comprising: a memory; and a processor coupled to the memory and configured to: acquire a first number from setting information including the first number and a second number when addition of another unit optical network different from any of the unit optical networks to the optical network is requested, the first number being the number of first optical channels used between the unit optical networks, the second number being the number of second optical channels used in a network of each of the unit optical networks belonging to the optical network; determine whether there are enough free optical channels in a database managing optical channels used in the optical network before a group of a third number of first optical channels that are used between each of the unit optical networks and the another unit optical network, is reserved in the database, the third number being a number according to the first number; and release some of predetermined optical channels that have been already reserved when the database does not have enough free optical channels, and allocate a reservation of the group of the third number of the first optical channels to free optical channels in the database after the some of the predetermined optical channels are released.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 illustrates an example of an All Photonics Network (APN).

FIG. 2 is a block diagram illustrating an example of a hardware configuration of an optical network controller.

FIG. 3 is a block diagram illustrating an example of a functional configuration of the optical network controller.

FIG. 4 is a diagram for describing an example of the table structure of a channel management table.

FIG. 5 is a diagram for describing an example of transition of the channel management table.

FIG. 6 is a diagram for describing an example of the APN in which an optical path is accommodated.

FIG. 7 is a flowchart illustrating an example of a first operation of the optical network controller.

FIG. 8 is a diagram for describing an example of the channel management table.

FIG. 9 is a diagram for describing another example of the APN in which an optical path is accommodated.

FIG. 10 is a diagram for describing another example of the channel management table.

FIG. 11 is a part of a flowchart illustrating an example of a second operation of the optical network controller.

FIG. 12 is a flowchart illustrating the remaining part of the example of the second operation of the optical network controller.

### DESCRIPTION OF EMBODIMENTS

In the design work for accommodating optical paths in an optical network (hereinafter, referred to as optical path accommodation design), the optical paths are designed based on demand forecast in advance. However, the optical paths designed based on demand forecasts may deviate from actual optical paths when the optical paths are opened.

For example, the actual optical paths may exceed the demand plan. In this case, a new node is added to the existing optical network. In addition, the actual optical paths may greatly exceed the demand plan. In this case, a new optical network is added to the existing optical network. When such scale-out (expansion) of the optical network occurs, redesign of the optical paths in the entire optical networks is required. If redesign of optical paths occurs, design load may increase.

Hereinafter, embodiments for carrying out the present disclosure will be described with reference to the drawings.

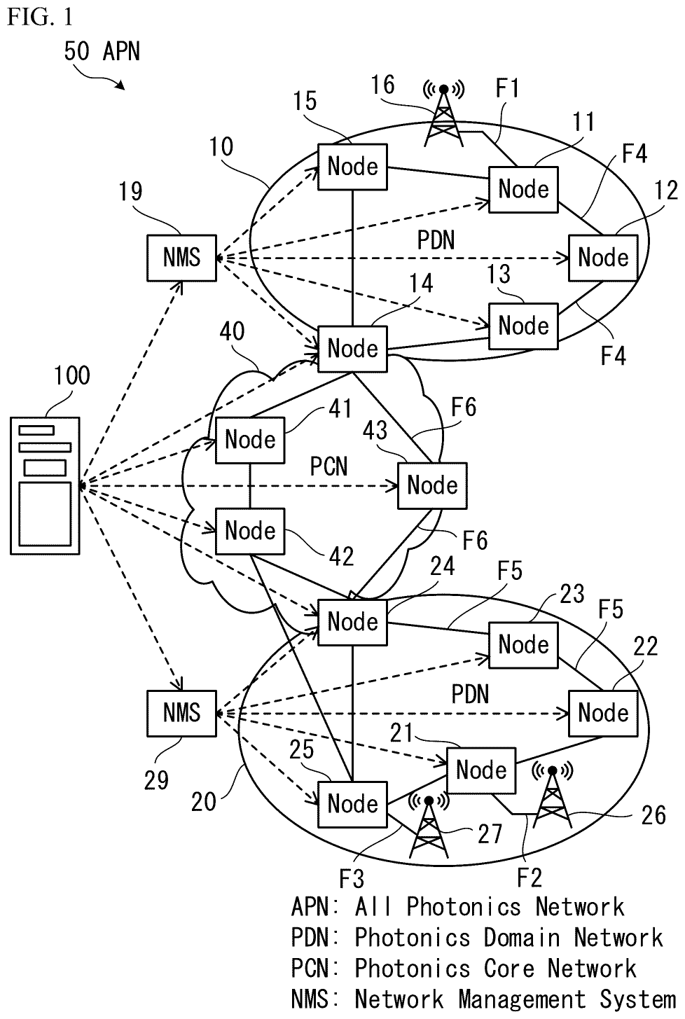

As illustrated in FIG. 1, an all photonics network (APN) 50 includes photonics domain networks (PDNs) 10, 20 and a photonics core network (PCN) 40. Each of the PDNs 10 and 20 and the PCN 40 is an example of a unit optical network.

The PDN 10 includes, for example, an optical metro network. The PDN 10 may include an optical access network instead of the optical metro network or in addition to the optical metro network. Since the PDN 20 has basically the same network configuration as the PDN 10 except that the communication service provider is different, detailed description thereof will be omitted.

The PDN 10 includes a plurality of nodes 11, 12, 13, 14, and 15, such as ROADMs, for example. The ROADM described in the present embodiment does not include a transponder that performs conversion between an optical signal and an electrical signal, but includes a wavelength selective switch (WSS). Therefore, each of the nodes 11, 12, 13, 14, and 15 outputs the input optical signal without converting the wavelength of the optical signal. The node 11 is connected to a mobile base station 16 via an optical transmission line F1 such as an optical fiber. Any of the nodes 12, 13, 14, and 15 may be connected to the mobile base station 16.

Similarly, the PDN 20 includes a plurality of nodes 21, 22, 23, 24, and 25. The node 21 is connected to a mobile base station 26 via an optical transmission line F2. The node 25 is connected to a mobile base station 27 via an optical transmission line F3. Any of the nodes 22, 23, and 24 may be connected to any of the mobile base stations 26 and 27.

The nodes 11, 12, 13, 14, and 15 are connected in a ring form by optical transmission lines F4. For example, the node 12 is connected to each of the nodes 11 and 13 adjacent to the node 12. The nodes 11, 12, 13, 14, and 15 may be connected in a mesh form by the optical transmission lines F4. In this case, the node 12 is connected not only to the nodes 11 and 13 adjacent to the node 12 but also to the nodes 14 and 15 not adjacent to the node 12.

Similarly, the nodes 21, 22, 23, 24, and 25 are connected in a ring form by optical transmission lines F5. The nodes 21, 22, 23, 24, and 25 may be connected in a mesh form by the optical transmission lines F5. The nodes 11, 12, 13, 14, and 15 may be connected in a linear form by the optical transmission lines F4. The nodes 21, 22, 23, 24, and 25 may be connected in a linear form by the optical transmission lines F5.

Optical paths are set for the nodes 11, 12, 13, 14, and 15 by a network management system (NMS) 19. The optical paths that are completed within the PDN 10 are set by the NMS 19. Similarly, optical paths are set for the nodes 21, 22, 23, 24, and 25 by an NMS 29. The optical paths that are completed in the PDN 20 are set by the NMS 29.

The PCN 40 includes a plurality of nodes 41, 42, and 43 as in the PDNs 10 and 20. In the PCN 40, the nodes 14 and 24 are shared as a point of interface (POI). Thus, the PCN 40 may include the nodes 14 and 24. The nodes 14, 24, 41, 42, and 43 are connected in a ring form by optical transmission lines F6. For example, the node 14 is connected to the nodes 41 and 43 adjacent to the node 14. The nodes 14, 24, 41, 42, and 43 may be connected in a mesh form by the optical transmission lines F6.

The nodes 41, 42, and 43 are directly monitored and controlled by an optical network controller 100. The optical network controller 100 is an example of an optical network management device. The node 14 is indirectly monitored and controlled by the optical network controller 100 via the NMS 19. The node 14 may be directly monitored and controlled by the optical network controller 100. Similarly, the node 24 is indirectly monitored and controlled by the optical network controller 100 via the NMS 29. The node 24 may be directly monitored and controlled by the optical network controller 100.

Thus, in the APN 50, the PDN 10 and the PCN 40 are optically connected. Therefore, the optical signal is not converted into the electrical signal between the PDN 10 and the PCN 40, and the optical signal is transmitted as it is. Similarly, in the APN 50, the PDN 20 and the PCN 40 are optically connected. Therefore, the optical signal is not converted into the electrical signal between the PDN 20 and the PCN 40, and the optical signal is transmitted as it is. Thus, the optical network controller 100 can collectively manage the optical paths accommodated in the APN 50.

In the present embodiment, in any of the nodes 11 to 25 and the nodes 41, 42, and 43, the wavelength conversion of the input optical signal is not performed, and an optical signal having the same wavelength as the wavelength of the input optical signal is output. For example, an optical path having the node 11 as a start node and the node 25 as an end node may be set and accommodated in the APN 50. In this case, optical signals having the same wavelength are transmitted end-to-end through the optical path as a communication path. In the APN 50, an optical path is allocated to each optical communication service. Thus, as optical communication services increase, a huge number of optical paths require wavelengths.

On the other hand, accommodation of optical paths and selection of wavelengths for avoiding collision between wavelengths are required as constraints. As described above, none of the nodes 11 to 25 and the nodes 41, 42, and 43 performs regeneration of an optical signal using an electrical signal, and performs wavelength conversion. If the optical signal is not regenerated, deterioration in the signal quality of the optical signal is accumulated, and the transmission distance of the optical signal is limited. That is, it is required to accommodate optical paths in consideration of not only the collision between wavelengths but also the transmission distance. That is, the APN 50 including such nodes 11 to 25, 41, 42, and 43 corresponds to a transparent optical network.

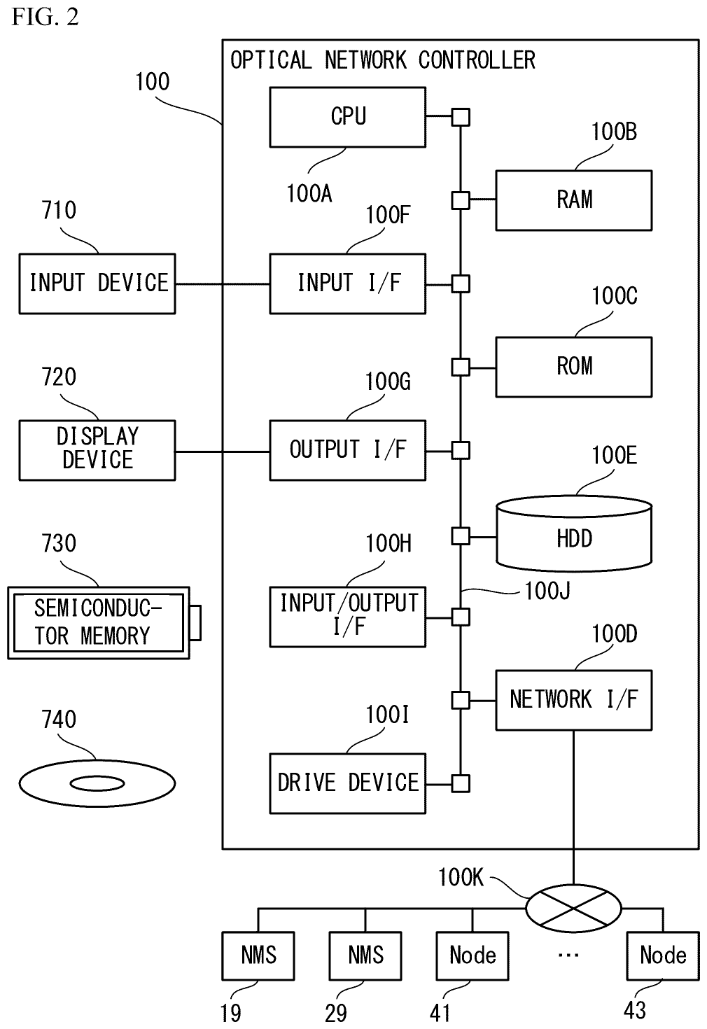

Next, a hardware configuration of the optical network controller 100 will be described with reference to FIG. 2.

The optical network controller 100 includes a central processing unit (CPU) 100A as a processor, and a random access memory (RAM) 100B and a read only memory (ROM) 100C as memories. The optical network controller 100 includes a network interface (I/F) 100D and a hard disk drive (HDD) 100E. Instead of the hard disk drive (HDD) 100E, a solid state drive (SSD) may be adopted as the storage device.

The optical network controller 100 may include at least one of an input I/F 100F, an output I/F 100G, an input/output I/F 100H, or a drive device 100I, as necessary. The CPU 100A to the drive device 100I are connected to each other by an internal bus 100J. That is, the optical network controller 100 can be implemented by a computer.

An input device 710 is connected to the input I/F 100F. Examples of the input device 710 include a keyboard, a mouse, and a touch panel. A display device 720 is connected to the output I/F 100G. Examples of the display device 720 include a liquid crystal display. A semiconductor memory 730 is connected to the input/output I/F 100H. Examples of the semiconductor memory 730 include a universal serial bus (USB) memory and a flash memory. The input/output I/F 100H reads the optical network management program stored in the semiconductor memory 730. The input I/F 100F and the input/output I/F 100H are provided with, for example, USB-ports. The output I/F 100G has, for example, a display port.

A portable recording medium 740 is inserted into the drive device 100I. Examples of the portable recording medium 740 include a removable disk such as a compact disc (CD)-ROM and a digital versatile disc (DVD). The drive device 100I reads the optical network management program recorded in the portable recording medium 740. The network I/F 100D has, for example, a LAN port and a communication circuit. The communication circuit includes one or both of a wired communication circuit and a wireless communication circuit. The network I/F 100D is connected to the NMSs 19 and 29, the nodes 41 to 43, and the like via a communication network 100K. The communication network 100K includes one or both of the Internet and a local area network (LAN).

The optical network management program stored in at least one of the ROM 100C, the HDD 100E, or the semiconductor memory 730 is temporarily stored in the RAM 100B by the CPU 100A. The optical network management program recorded in the portable recording medium 740 is temporarily stored in the RAM 100B by the CPU 100A. The CPU 100A executes the stored optical network management program, and thereby the CPU 100A implements various functions described later and executes an optical network management method including various processes described later. The optical network management program may be in accordance with a flowchart described later.

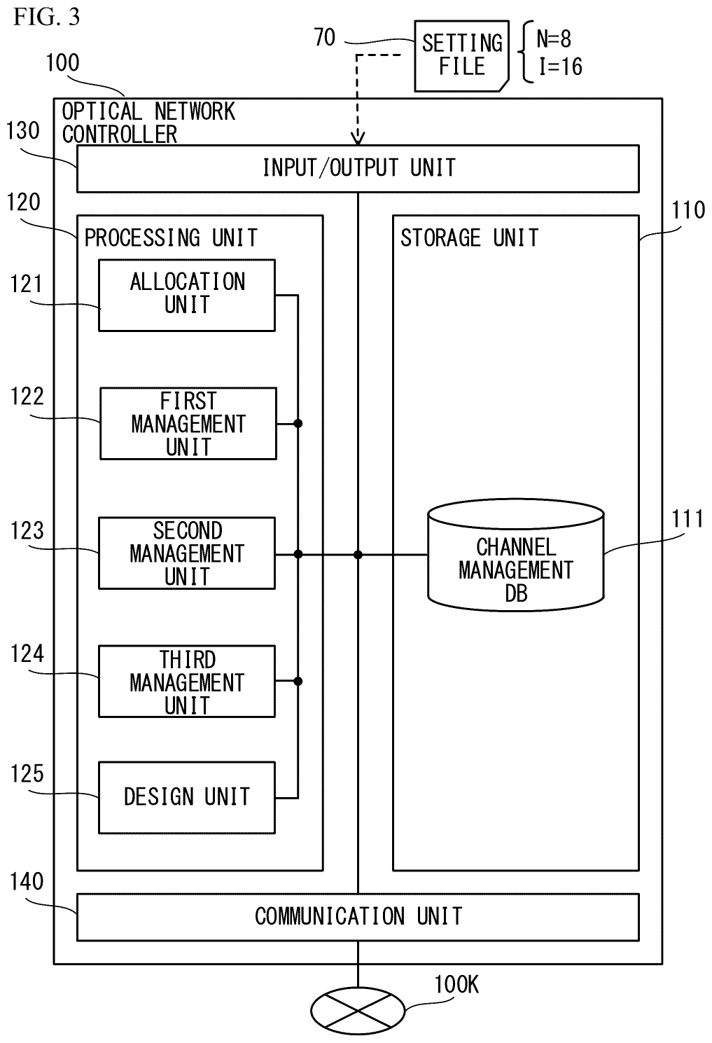

The functional configuration of the optical network controller 100 will be described with reference to FIG. 3 to FIG. 6. In FIG. 3, key functions of the optical network controller 100 are illustrated.

As illustrated in FIG. 3, the optical network controller 100 includes a storage unit 110, a processing unit 120, an input/output unit 130, and a communication unit 140. The storage unit 110 can be implemented by one or both of the RAM 100B and the HDD 100E described above. The processing unit 120 can be implemented by the CPU 100A described above. The input/output unit 130 can be implemented by the input/output I/F 100H described above. The communication unit 140 can be implemented by the above-described network I/F 100D.

The storage unit 110, the processing unit 120, the input/output unit 130, and the communication unit 140 are connected to each other. The storage unit 110 includes a channel management database (DB) 111. The processing unit 120 includes an allocation unit 121, a first management unit 122, a second management unit 123, a third management unit 124, and a design unit 125. The allocation unit 121 is an example of an acquisition unit and a reservation unit. The second management unit 123 is an example of a determination unit.

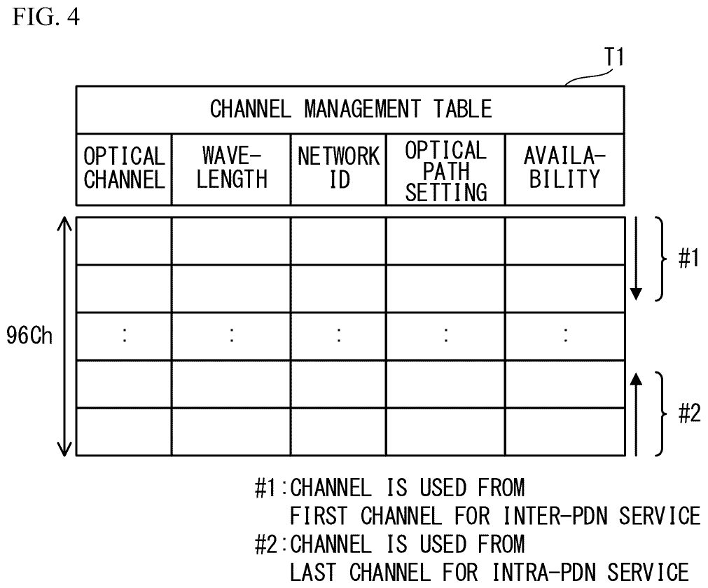

The channel management DB 111 is a database for managing the inventory of wavelengths used in optical communication services. The channel management DB 111 manages the inventory of wavelengths with a channel management table T1 as illustrated in FIG. 4. The channel management table T1 manages, for example, 96 wavelengths λ1, . . . , λ96 belonging to the C band (Conventional Band) in association with optical channels “Ch01” to “Ch96” that are identification numbers.

The C band is, for example, a waveband of 1530 nm (nanometers) to 1565 nm. For example, the optical channel “Ch01” is associated with the shortest wavelengths λ1 belonging to the C band. The optical channel “Ch96” is associated with the wavelength λ96, which is the longest wavelength belonging to the C band. For example, 48 wavelengths may be adopted instead of 96 wavelengths as the number of wavelengths. In this case, since the number of optical channels corresponds to the number of wavelengths, the optical channels “Ch01” to “Ch48” are adopted.

The long band (L band) may be added to the C band. The L band is a long wavelength waveband from 1565 nm to 1625 nm, for example. In this case, 96 wavelengths belonging to the L band are added, and a total of 192 wavelengths are used to provide optical communication services. In addition, the short band (S band) may be further added to the C band and the L band. The S band is, for example, a waveband from 1460 nm to 1530 nm. In this case, 96 wavelengths belonging to the S band are added, and a total of 288 wavelengths are used to provide optical communication services.

Here, when opening of an inter-domain service, which is an optical communication service between the PDNs 10 and 20 across the PCN 40, is requested, the optical channel “Ch01” corresponding to the first row of the channel management table T1 is first selected and used. Thereafter, when opening of another inter-domain service between the PDNs 10 and 20 is requested, if the optical channel “Ch01” is used, the optical channel “Ch02” corresponding to the row one after the first row is selected and used. Thus, for the inter-domain service, the optical channels are used in ascending order.

On the other hand, when opening of an intra-domain service, which is an optical communication service in the PDN 20 that does not cross over the PCN 40, is requested, the optical channel “Ch96” corresponding to the last row of the channel management table T1 is first selected and used. Thereafter, when opening of another intra-domain service in the PDN 20 is requested, if the optical channel “Ch96” is used, the optical channel “Ch95” corresponding to the row immediately before the last row is selected and used. In this manner, for the intra-domain service, the optical channels are selected and used in descending order. The optical communication service in the PDN 10 is the same as the optical communication service in the PDN 20, and thus detailed description thereof will be omitted.

Referring back to FIG. 3, the allocation unit 121 acquires the predetermined number of channels from a setting file 70 for initial setting. The setting file 70 is an example of setting information. The setting file 70 may be stored in the semiconductor memory 730 or may be stored in the storage unit 110 in advance. The setting file 70 includes the number N of optical channels used in the inter-domain service (hereinafter referred to as the inter-domain channel number). The inter-domain channel number N is an example of a first channel number. The setting file 70 also includes the number I of optical channels used in the intra-domain service (hereinafter referred to as the intra-domain channel number). The intra-domain channel number I is an example of a second channel number.

The allocation unit 121 acquires the inter-domain channel number N and the intra-domain channel number I as the predetermined number. In the present embodiment, the inter-domain channel number N is eight. In the present embodiment, the intra-domain channel number I is 16. The inter-domain channel number N and the intra-domain channel number I may be changed as appropriate.

The intra-domain channel number I may be determined as a multiple of the inter-domain channel number N. For example, the intra-domain channel number I may be determined as an integer multiple of the inter-domain channel number N, such as twice or three times. Although details will be described later, the allocation unit 121 acquires the inter-domain channel number N and the intra-domain channel number I when addition of another PDN different from either the PDN 10 or 20 to the APN 50 is requested.

The allocation unit 121 allocates a reservation of groups of the same number of optical channels as the inter-domain channel number N, which are used between each of the PDNs 10 and 20 and another PDN, respectively. Specifically, the allocation unit 121 allocates a reservation of the same number of optical channels as a multiple of the inter-domain channel number N.

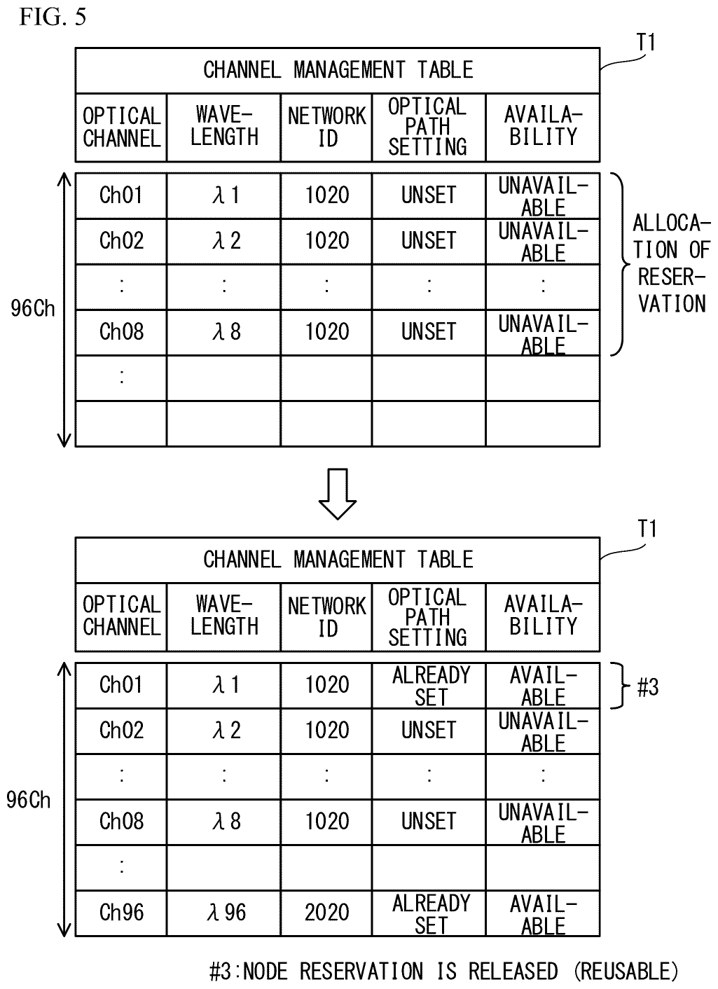

For example, when a reservation of a group of the same number of optical channels as one time the inter-domain channel number N is allocated, as illustrated in the upper part of FIG. 5, the allocation unit 121 allocates a reservation of a group of eight optical channels from the optical channel “Ch01” to the optical channel “Ch08”. At the stage when such a group of optical channels is reserved, an optical path is not set. Therefore, no optical channel is allocated to the optical path. At the stage when a group of optical channels is reserved, “unavailable” is registered as the availability of each optical channel. At this stage, the identification number “1020” for identifying the inter-domain service provided between the PDNs 10 and 20 is registered as the network ID for each optical channel in the group.

The first management unit 122 manages optical channels used for the intra-domain service among the optical channels managed in the channel management table T1. Specifically, the first management unit 122 manages the number of optical channels used in the intra-domain service. For example, when the number of optical channels in use in either the PDN 10 or 20 exceeds the intra-domain channel number I at the specific timing of adding the another PDN described above, the first management unit 122 displays a message suggesting the addition of a node.

The second management unit 123 manages optical channels used for the inter-domain service among the optical channels managed in the channel management table T1. Specifically, the second management unit 123 manages the number of optical channels used in the inter-domain service. The second management unit 123 determines whether there are free channels in the channel management DB 111 (in particular, the channel management table T1) before the allocation unit 121 allocates the above-described group of optical channels to the channel management DB 111. When the second management unit 123 determines whether there are free channels in the channel management DB 111, the second management unit 123 notifies the allocation unit 121 of the determination result.

The third management unit 124 manages reusable optical channels. Even if optical channels to be used in the inter-domain service are reserved, when opening of the inter-domain service is requested, one or some of the reserved optical channels may have been already used in the inter-domain service. In such a case, the third management unit 124 manages the remaining reserved optical channels as reusable optical channels, and selects a reusable optical channel as necessary.

When opening of an optical communication service is requested, the design unit 125 designs an optical path, and sets and accommodates the designed optical path in the APN 50. The design unit 125 may be requested to open an inter-domain service in which a start node and an end node are specified together with a network ID. In this case, when the second management unit 123 selects one of the optical channels to which the reservation is allocated, the design unit 125 designs an optical path from the start node to the end node based on the transmission deterioration factor such as PMD and a predetermined algorithm. The predetermined algorithm is, for example, integer linear programming.

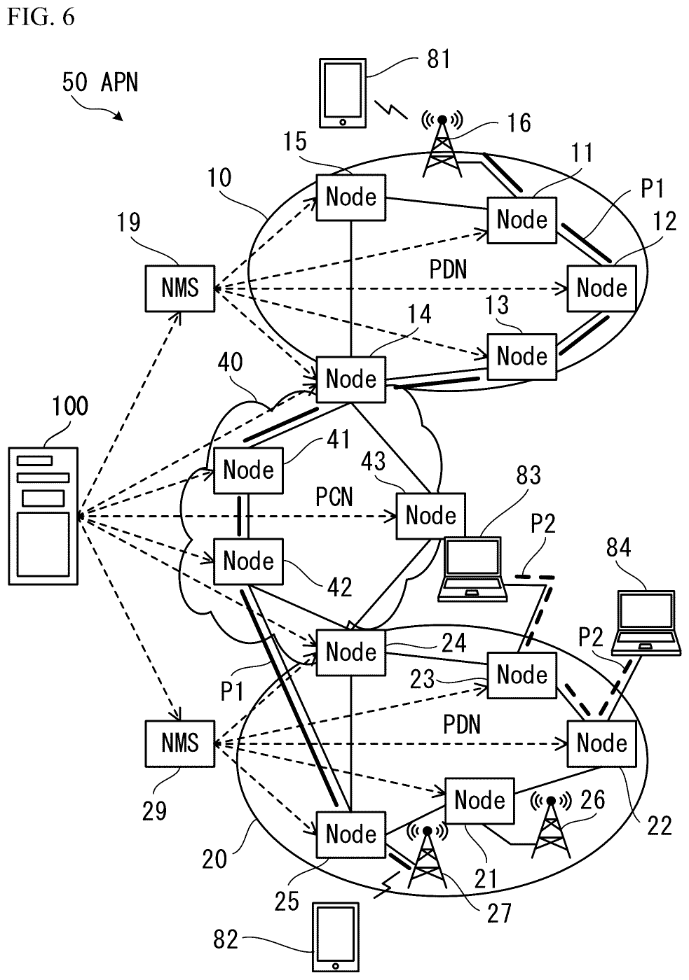

The design unit 125 may design one optical path or may design a plurality of optical paths. When the design unit 125 designs a plurality of optical paths, the design unit 125 can output information for requesting selection of one of the optical paths to the display device 720. When one optical path is designed, the design unit 125 allocates the selected optical channel to the designed optical path, and sets and accommodates the optical path in the APN 50. For example, as illustrated in FIG. 6, the design unit 125 sets and accommodates an optical path P1, to which the optical channel “Ch01” is allocated, between the PDNs 10 and 20 across the PCN 40. This allows mobile terminals 81 and 82 such as smartphones to use the inter-domain service via the optical path P1.

When the optical path P1 is accommodated, as illustrated in the lower part of FIG. 5, the second management unit 123 changes the optical path setting to which the optical channel “Ch01” is allocated from “unset” to “already set”. The second management unit 123 maintains the optical path setting to which the optical channel “Ch01” is not allocated as “unset”. The second management unit 123 collects nodes to which the optical channel “Ch01” has not been allocated in the entire network, determines available inter-domain services, and then designates the optical channel “Ch01” as a reusable optical channel.

As described above, when an optical path is set, the reservation of the remaining nodes that are not allocated to the optical path is released, the use of the optical channel is permitted, and the optical channel is designated as a reusable optical channel. On the other hand, the second management unit 123 maintains the availability of the optical paths to which the optical channels “Ch02” to “Ch08” are allocated as “unavailable”.

On the other hand, when opening of the intra-domain service in which the start node and the end node are specified together with the network ID is requested, the design unit 125 selects one of unused optical channels. When the optical channel is selected, the design unit 125 designs an optical path from the start node to the end node, as in the case of the inter-domain service. For example, as illustrated in FIG. 6, the design unit 125 sets and accommodates an optical path P2 of the optical channel “Ch96” in the PDN 20.

This allows mobile terminals 83 and 84 such as personal computers (PCs) to use the intra-domain service via the optical path P2. When the optical path P2 is accommodated, as illustrated in the lower part of FIG. 5, the first management unit 122 registers “already set” in the optical path setting and registers “available” in the availability.

Here, there is a case where the number of free channels in the channel management table T1 is insufficient before the allocation unit 121 reserves a group of optical channels. In this case, the second management unit 123 releases one or some of the predetermined optical channels that have been already reserved from the channel management table T1 by deletion, and allocates the reservation of the group of optical channels to free channels in the channel management table T1 after the release of one or some of the predetermined optical channels, which will be described in detail later.

As described above, a group of optical channels is dynamically reserved according to the timing at which the channel management table T1 runs short of free channels. Therefore, even when the scale-out of the APN 50 occurs, the optical path for the APN 50 is not redesigned. This reduces the design load in the optical path accommodation design.

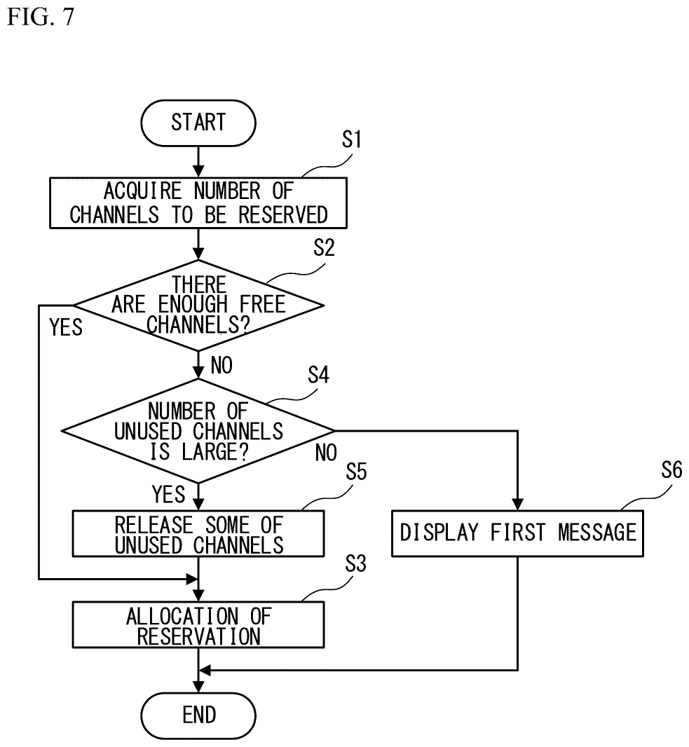

Next, a first operation of the optical network controller 100 will be described with reference to FIG. 7 to FIG. 10.

First, as illustrated in FIG. 7, the allocation unit 121 acquires the number of channels to be reserved (step S1). For example, when addition of another PDN different from the PDNs 10 and 20 is requested through the input device 710 in a state where the PDNs 10 and 20 are already included in the APN 50 (see FIG. 1), the allocation unit 121 acquires the number of channels to be reserved. In this case, the allocation unit 121 accesses the setting file 70 and acquires the inter-domain channel number N (for example, N=8) included in the setting file 70 as the number of channels to be reserved.

When the allocation unit 121 acquires the number of channels to be reserved, the second management unit 123 determines whether there are enough free channels in the channel management table T1 (step S2). More specifically, the second management unit 123 accesses the channel management DB 111 and determines whether there are the same number of free channels as a multiple of the number of channels to be reserved in the channel management table T1. That is, the second management unit 123 determines whether there are the same number of unused channels as a multiple of the number of channels to be reserved in the channel management table T1.

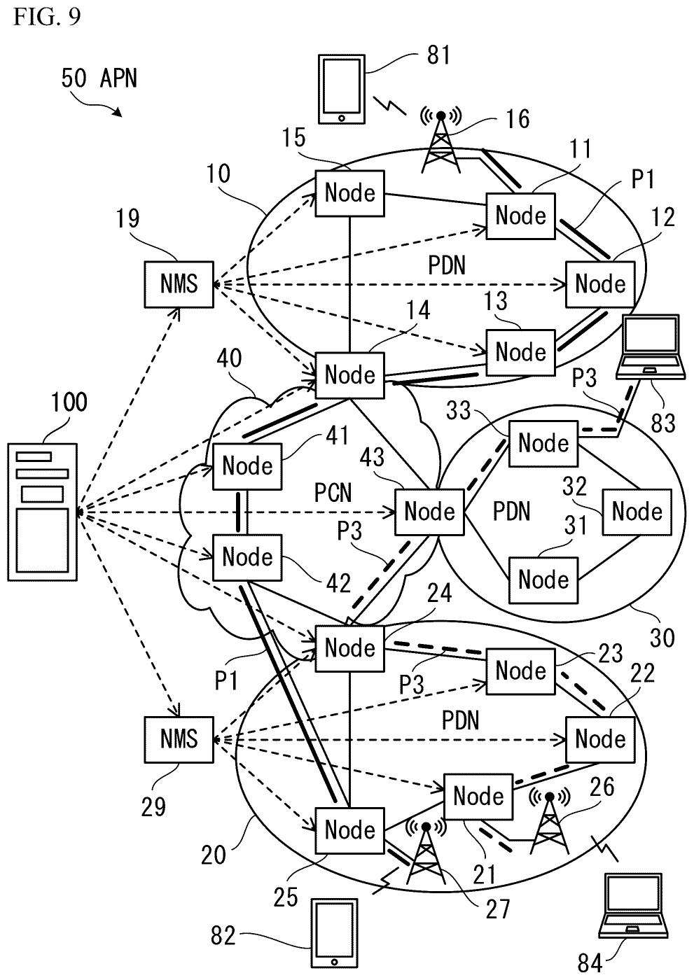

For example, in a state where the PDNs 10 and 20 are already included in the APN 50, as illustrated in FIG. 9, the addition of another PDN 30 different from the PDNs 10 and 20 may be requested. The PDN 30 includes a plurality of nodes 31, 32, and 33, e.g., similar to the nodes 11 and 21, etc. The communication service provider managing the PDN 30 is different from each of the communication service providers managing the respective PDNs 10 and 20. When such addition of the PDN 30 is requested, requested is the allocation of reservations of groups of the same number of optical channels as the number of channels to be reserved for optical paths to be set between the PDNs 10 and 30 and optical channels to be set between the PDNs 20 and 30, respectively. That is, the allocation of the reservation of eight optical channels for optical paths to be set between the PDNs 10 and 30 is requested, and the allocation of the reservation of eight optical channels for optical paths to be set between the PDNs 20 and 30 is requested. As a result, when the addition of the PDN 30 is requested, the allocation of the reservation of 16 optical channels corresponding to twice the number of channels to be reserved is requested. Here, the channel management table T1 is partially occupied by the existing eight optical channels for optical paths between the PDNs 10 and 20. Therefore, when the PDN 30 is added, the channel management table T1 is occupied by 24 (=8+16) optical channels.

Although not illustrated, similarly, when the addition of a fourth PDN is requested in a state where the APN 50 already includes three PDNs 10, 20, and 30, the allocation of the reservation of 24 optical channels is requested. Thus, the channel management table T1 is occupied by 48 (=24+24) optical channels. When addition of a fifth PDN is requested, allocation of the reservation of 32 optical channels is requested. Thus, the channel management table T1 is occupied by 80 (=48+32) optical channels.

In this manner, every time a PDN is added, free channels (unused channels) in the channel management table T1 decrease. Here, a case where the channel management table T1 is occupied by 17 optical channels from the end of the channel management table T1 based on the intra-domain service will be considered. In this case, when the addition of the fifth PDN is requested, the area of the channel management table T1 in which 96 optical channels are reserved is exceeded. This is because 80 optical channels already occupy the channel management table T1. Therefore, a process different from the above-described addition process is required for adding the fifth PDN to the APN 50. In this manner, the second management unit 123 determines whether there are free channels in the channel management table T1 every time addition of a PDN is requested.

When the optical channel based on the intra-domain service is not occupied at all and the addition of the fifth PDN is permitted, the channel management table T1 is occupied by 80 optical channels as described above. When the addition of the sixth PDN is requested in this state, the allocation of the reservation of 40 optical channels is requested. Also in such a case, a process different from the above-described addition process is required for adding the sixth PDN to the APN 50.

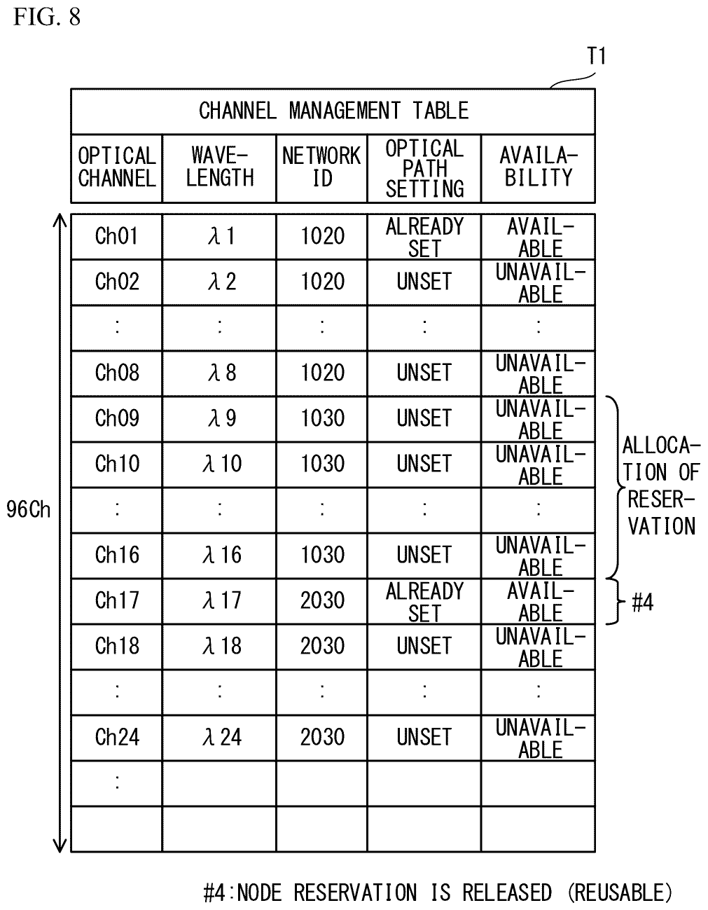

In the process of step S2, when there are enough free channels in the channel management table T1 (step S2: YES), the allocation unit 121 allocates a reservation of a group of optical channels (step S3), and ends the process. For example, the allocation unit 121 allocates reservations of groups of the same number of optical channel as the number of optical channels to be reserved for optical paths to be set between the PDNs 10 and 30 and optical paths to be set between the PDNs 20 and 30, respectively. As a result, as illustrated in FIG. 8, a reservation of a group of eight optical channels from the optical channel “Ch09” to the optical channel “Ch16” is allocated for optical paths to be set between the PDNs 10 and 30. Further, a reservation of a group of eight optical channels from the optical channel “Ch17” to the optical channel “Ch24” is allocated for optical paths to be set between the PDNs 20 and 30.

Here, as in the inter-domain service between the PDNs 10 and 20, as illustrated in FIG. 9, there is a case where opening of the inter-domain service between the PDNs 20 and 30 is requested and the optical path P3 is accommodated. In this case, the design unit 125 sets and accommodates the optical path P3, to which the optical channel “Ch17” is allocated, between the PDNs 20 and 30 across the PCN 40. This allows the mobile terminals 83 and 84 to use the inter-domain service via the optical path P3.

Then, as illustrated in FIG. 8, the second management unit 123 changes the optical path setting of the optical channel “Ch17” from “unset” to “already set”, for example. The second management unit 123 designates the optical channel “Ch17” as a reusable optical channel, and the third management unit 124 manages the designated reusable optical channel.

On the other hand, in the process of step S2, when there are not enough free channels in the channel management table T1 (step S2: NO), the second management unit 123 determines whether the number of unused optical channels in the group of optical channels to which the reservation has been already allocated is large (step S4). For example, as illustrated in FIG. 8, “unavailable” is registered as the availability for a group of the seven optical channels from the optical channel “Ch02” to the optical channel “Ch08” to be used in the inter-domain service between the PDNs 10 and 20. That is, a group of these seven optical channels is not used. Similarly, “unavailable” is registered as the availability for a group of the seven optical channels from the optical channel “Ch18” to the optical channel “Ch24” to be used in the inter-domain service between the PDNs 20 and 30. That is, a group of these seven optical channel is also unused.

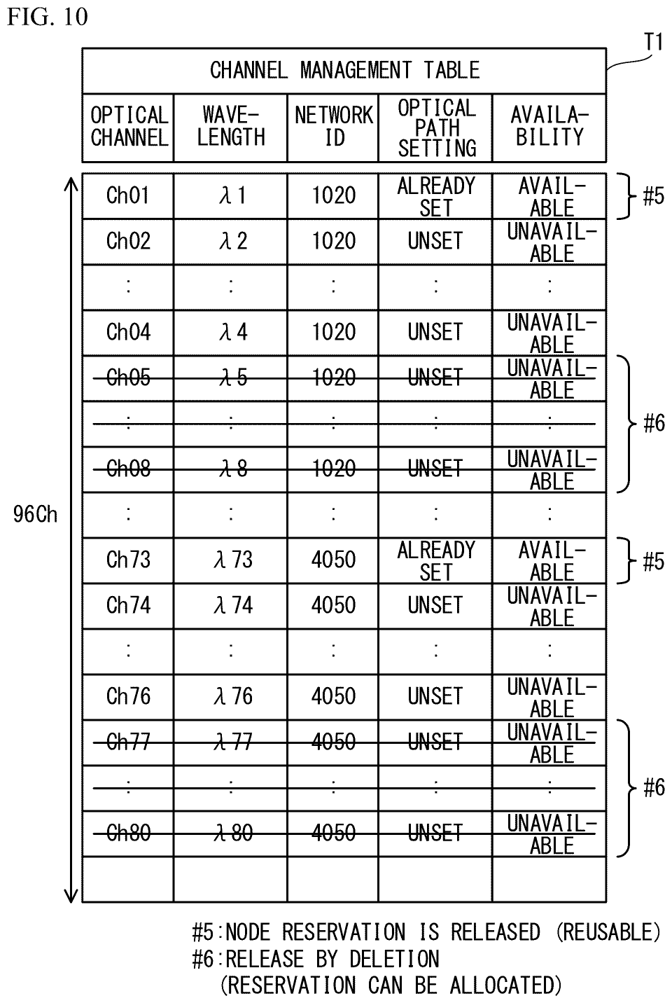

When the number of unused optical channels is equal to or greater than a predetermined value, for example, five, the second management unit 123 determines that the number of unused optical channels is large (step S4: YES). In this case, the second management unit 123 releases some of the unused optical channels in the group by deletion (step S5). For example, as illustrated in FIG. 10, the second management unit 123 releases a group of four optical channels from the group of the seven optical channels from the optical channels “Ch02” to the optical channel “Ch08” by deletion. At this time, the second management unit 123 releases a group of the four optical channels from the optical channel “Ch05” to the optical channel “Ch08”, which are the latter portions of the seven optical channels in the group, from the allocation of the reservation by deletion. Similarly, the second management unit 123 releases a group of the four optical channels from the optical channel “Ch74” to the optical channel “Ch80”, which are the latter portions of the seven optical channels from the optical channel “Ch77” to the optical channel “Ch80” in the group. The same applies to the remaining inter-domain services omitted in FIG. 10. The number of deleted channels may be two or three.

In this manner, the second management unit 123 releases, by deletion, some of the unused optical channels in the group for optical paths between domains such as optical paths between the PDNs 10 and 20 and optical paths between the PDNs 20 and 30. In addition, when the optical path to which the optical channel “Ch09” is allocated is accommodated in the APN 50, the second management unit 123 releases, by deletion, some of the unused optical channels in the group for optical paths between the PDNs 10 and 30 in the same manner. Thus, when the addition of the sixth PDN is requested, the second management unit 123 secures the free channels for 40 optical channels. Thus, even when addition of the sixth PDN is requested, the allocation unit 121 can allocate the reservation of a group of the optical channels to the free channels secured by the second management unit 123. In this manner, after the second management unit 123 releases some of unused optical channels in the group, the allocation unit 121 executes the process of step S3 and ends the process.

In the process of step S4, when the number of unused optical channels is less than the predetermined number, the second management unit 123 determines that the number of unused optical channels is small (step S4: NO). In this case, the second management unit 123 displays a first message (step S6), and ends the process. For example, the second management unit 123 displays a message suggesting the addition of a new APN different from the APN 50 on the display device 720 as the first message, and ends the process. This allows an operator to consider adding a new APN.

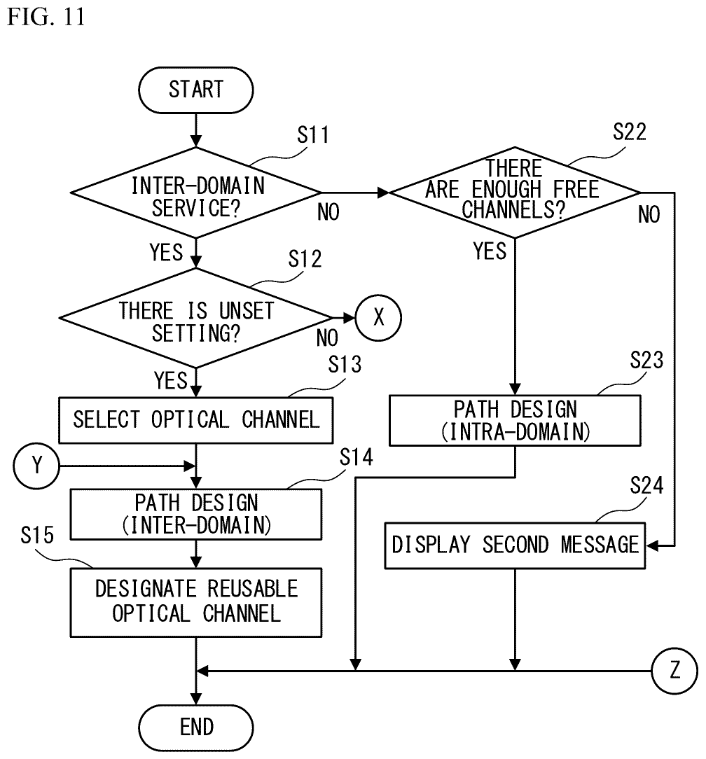

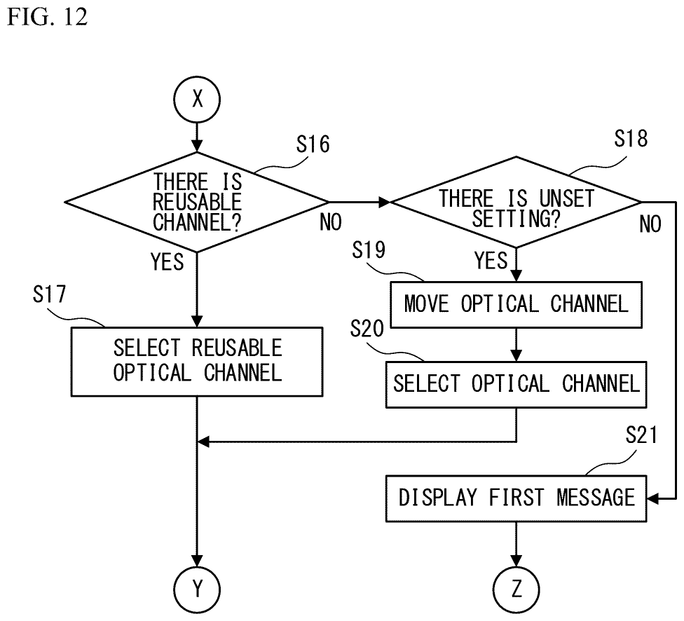

Next, a second operation of the optical network controller 100 will be described with reference to FIG. 11 and FIG. 12.

First, as illustrated in FIG. 11, the design unit 125 determines whether the optical communication service is an inter-domain service (step S11). For example, when opening of an optical communication service is requested from the input device 710, the design unit 125 determines whether an PDN-to-PDN service is requested as the optical communication service, based on the network ID. The person in charge of the operation of the APN 50 can specify the network ID and input it to the input device 710.

When the optical communication service is an inter-domain service (step S11: YES), the second management unit 123 determines whether there are any unset settings (step S12). For example, the second management unit 123 accesses the channel management table T1. When accessing the channel management table T1, the second management unit 123 checks the setting status of the optical path setting associated with the network ID, and determines whether there is an unset optical path setting.

When there are any unset settings (step S12: YES), the second management unit 123 selects one of the optical channels (step S13). More specifically, the second management unit 123 selects an optical channel having the smallest channel number from among the optical channels for which optical paths have not been set. For example, when the setting status of eight optical channels from the optical channel “Ch01” to the optical channel “Ch08” is “unset” (see the upper part of FIG. 5), the second management unit 123 selects the optical channel of the optical channel “Ch01” located at the head. For example, when the setting statuses of the seven optical channels from the optical channel “Ch02” to the optical channel “Ch08” are “unset” (see the lower part of FIG. 5), the second management unit 123 selects the optical channel of the optical channel “Ch02” located at the next head.

When the second management unit 123 selects one of the optical channels, the design unit 125 designs an optical path for the inter-domain service (step S14). That is, the design unit 125 designs an optical path to which the selected optical channel is allocated, and accommodates the designed optical path. Thus, for example, the optical path P1 is accommodated between the PDNs 10 and the 20 (see FIG. 6). When the design unit 125 designs the optical path, the second management unit 123 designates the selected optical channel as a reusable optical channel (step S15). When the second management unit 123 designates the selected optical channel as a reusable optical channel, the third management unit 124 manages the reusable optical channel designated by the second management unit 123 in the channel management table T1, and ends the process.

Here, in the process of step S12, when there is no unset setting (step S12: NO), as illustrated in FIG. 12, the third management unit 124 determines whether there is a reusable optical channel (step S16). More specifically, the third management unit 124 accesses the channel management table T1 and determines whether there is a reusable optical channel corresponding to the network ID.

When there is a reusable optical channel (step S16: YES), the third management unit 124 selects one of the reusable optical channels (step S17). More specifically, the third management unit 124 selects the reusable optical channel having the smallest optical channel number. As a result, as illustrated in FIG. 11, the design unit 125 designs an optical path to which the reusable optical channel is allocated by the process of step S14. Then, the third management unit 124 designates the remaining reusable optical channels as reusable optical channels again by the process of step S15, and ends the process.

On the other hand, as illustrated in FIG. 12, in the process of step S16, when there is no reusable optical channel (step S16: NO), the second management unit 123 determines whether there is an unset setting (step S18). In this case, the second management unit 123 accesses the channel management table T1 and identifies another network ID different from the network ID designated in the opening of the inter-domain service. When the second management unit 123 identifies another network ID, the second management unit 123 checks the setting status of the optical path setting associated with the designated another network ID and determines whether there is an unset setting in the optical path settings.

When there is an unset setting (step S18: YES), the second management unit 123 moves the optical channel (step S19). More specifically, when a plurality of other network IDs are identified, the second management unit 123 calculates the setting rate of the optical path of each of the identified other network IDs. When the setting rate is calculated, the second management unit 123 identifies another network ID having the lowest setting rate. When the second management unit 123 identifies another network ID, the second management unit 123 selects one of the optical channels associated with the identified another network ID as a movement target.

When the second management unit 123 selects one of the optical channels as a movement target, the second management unit 123 moves the selected optical channel to a row corresponding to the network ID specified in the opening of the inter-domain service. For example, when the second management unit 123 identifies the network ID “4050”, the second management unit 123 moves the optical channel “Ch76” associated with the network ID “4050” to the row corresponding to the network ID “1020”.

When the optical channel is moved, the second management unit 123 selects the moved optical channel (step S20). As a result, as illustrated in FIG. 11, the design unit 125 designs an optical path to which the moved optical channel is allocated by the process of step S14. Then, the second management unit 123 designates the remaining optical channels as reusable optical channels by the process of step S15, and ends the process. In the process of step S18, when there is no unset setting (step S18: NO), the second management unit 123 displays the first message (step S21), and ends the process as illustrated in FIG. 11.

In the process of step S11, when the optical communication service is not an inter-domain service (step S11: NO), the first management unit 122 determines whether there are enough free channels (step S22). For example, when the optical communication service is not an inter-domain service, the first management unit 122 determines that the optical communication service is an intra-domain service, accesses the channel management table T1, and determines whether there are the same number of free optical channels as the intra-domain channel number I.

When there are enough free channels (step S22: YES), the design unit 125 designs an optical path for the intra-domain service (step S23), and ends the process. More specifically, the first management unit 122 checks the channel management table T1 and selects one optical channel from the last. When the first management unit 122 selects an optical channel, the design unit 125 designs an optical path to which the selected optical channel is allocated, and accommodates the designed optical path.

Thus, for example, the optical path P2 is accommodated in the PDN 20 (see FIG. 6). On the other hand, when there is no free channel (step S22: NO), the first management unit 122 displays a second message (step S24), and ends the process. For example, the first management unit 122 displays a message suggesting the addition of a node (specifically, a route) on the display device 720 as the second message, and ends the process.

As described above, the optical network controller 100 according to the present embodiment determines whether there are free channels in the channel management table T1, for example, every time addition of a new PDN (for example, the PDN 30) is requested. More specifically, the optical network controller 100 determines whether there are enough free channels to be reserved for a group of the inter-domain channel number N of optical channels in the channel management table T1 with respect to each of the existing PDNs (for example, the PDNs 10 and 20, etc.) to which reservations have already been allocated.

When there is no such free channel, the optical network controller 100 releases the latter portions of the optical channels related to the existing PDN reserved in the channel management table T1 by deletion. Then, the optical network controller 100 allocates the reservation of the optical channels according to the addition of the new PDN to the released latter portions. This allows the addition of a new PDN.

That is, according to the present embodiment, it is possible to perform an on-demand operation in which an optical path is set only at a necessary timing. In particular, when the PDNs 10 and 20 and the PCN 40 are of mesh types, a complex optical path is accommodated in the APN 50 as compared with a ring type, but even in such a case, the pre-design of the optical path is not required. In addition, even when scale-out such as addition of a node or addition of a new PDN occurs, redesign of the optical path in the APN 50 is not required. As described above, according to the present embodiment, the design load in the optical path accommodation design is reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various change, substitutions, and alterations could be made hereto without departing from the spirit and scope of the invention.

For example, the setting file 70 may include a frequency band (for example, 400 GHz) corresponding to the inter-domain channel number N instead of the inter-domain channel number N. The setting file 70 may include a wavelength band corresponding to the inter-domain channel number N. Even when the setting file 70 includes such a frequency band or wavelength band, the design load in the optical path accommodation design is reduced as in the above-described embodiment.

What is claimed is:

1. An optical network management device that manages an optical network in which unit optical networks are optically connected, the optical network management device comprising:
a memory; and
a processor coupled to the memory and configured to:
acquire a first number from setting information including the first number and a second number when addition of another unit optical network different from any of the unit optical networks to the optical network is requested, the first number being the number of first optical channels used between the unit optical networks, the second number being the number of second optical channels used in a network of each of the unit optical networks belonging to the optical network;
determine whether there are enough free optical channels in a database managing optical channels used in the optical network before a group of a third number of first optical channels that are used between each of the unit optical networks and the another unit optical network, is reserved in the database, the third number being a number according to the first number; and
release some of predetermined optical channels that have been already reserved when the database does not have enough free optical channels, and allocate a reservation of the group of the third number of the first optical channels to free optical channels in the database after the some of the predetermined optical channels are released.

2. The optical network management device according to claim 1, wherein the processor is configured to release latter portions of the predetermined optical channels and allocate a reservation of the group of the third number of the first optical channels to the free optical channels in the database after some of the predetermined optical channels are released.

3. The optical network management device according to claim 1, wherein the processor is configured to allocate, to the database, a reservation of the group of the third number of the first optical channels used between each of the unit optical networks and the another unit optical network, the third number being a multiple of the first number.

4. The optical network management device according claim 1, wherein the processor is configured to, when it is determined that an optical path is set for a part of the group of the third number of the first optical channels, release allocation of a reservation to a remaining part of the group of the third number of the first optical channels and permit reuse of the remaining part.

5. The optical network management device according to claim 1, wherein the processor is configured to display a message suggesting addition of a new unit optical network different from any of the unit optical networks and the another unit optical network when the database does not have enough free optical channels and the number of unused optical channels in the group of the third number of the first optical channels is less than a threshold number.

6. The optical network management device according to claim 1, wherein at least one of the unit optical networks includes a plurality of nodes connected in a mesh form, and each of the plurality of nodes outputs an input optical signal without converting a wavelength of the input optical signal.

7. The optical network management device according to claim 1, wherein a single wavelength is allocated for each of a plurality of optical paths accommodated in the unit optical networks for each optical communication service.

8. An optical network management method for managing an optical network in which unit optical networks are optically connected, the method comprising:
acquiring a first number from setting information including the first number and a second number when addition of another unit optical network different from any of the unit optical networks to the optical network is requested, the first number being the number of first optical channels used between the unit optical networks, the second number being the number of second optical channels used in a network of each of the unit optical networks belonging to the optical network;
determining whether there are enough free optical channels in a database managing optical channels used in the optical network before a group of a third number of first optical channels that are used between each of the unit optical networks and the another unit optical network, is reserved in the database, the third number being a number according to the first number; and
releasing some of predetermined optical channels that have been already reserved when the database does not have enough free optical channels, and allocating a reservation of the group of the third number of the first optical channels to free optical channels in the database after the some of the predetermined optical channels are released.
